(19) United States
(12) Patent Application Publication
(10) Pub. No.: US 2026/0026443 A1
(43) Pub. Date: Jan. 29, 2026

(54) METHODS FOR ENHANCING BIOACTIVE PHYTOCHEMICALS

(71) Applicant: The Texas A&M University System, College Station, TX (US)

(72) Inventors: Bhimanagouda Patil, College Station, TX (US); Deepak Kumar Jha, College Station, TX (US); Hisashi Koiwa, College Station, TX (US); Samikshya Bhattarai, College Station, TX (US)

(21) Appl. No.: 19/237,970

(22) Filed: Jun. 13, 2025

Related U.S. Application Data
(60) Provisional application No. 63/675,903, filed on Jul. 26, 2024.

(51) Int. Cl. A01G 7/04

(52) U.S. Cl. CPC A01G 7/045

(57) ABSTRACT

Methods for increasing carotenoid content in a plant and increasing lycopene content in a plant are provided. The methods comprise using blue light and UV-B light alone or in combination in order to increase carotenoid content in a plant. Also provided are methods for increasing the nutritional content of a plant by inducing the conversion of trans-lycopene to cis-lycopene in whole fruit.

### CROSS REFERENCE TO RELATED APPLICATIONS

This application claims the benefit of priority of U.S. Provisional Patent Appl. Ser. No. 63/675,903, filed Jul. 26, 2024, the entire disclosure of which is incorporated herein by reference.

### FIELD OF THE INVENTION

The present invention relates to the fields of plant biochemistry and crop science. More specifically, the present invention relates to methods for increasing carotenoid content in a tomato plant using light and increasing the conversion of trans-lycopene into cis-lycopene in such plants.

### BACKGROUND OF THE INVENTION

Tomatoes (Solanum lycopersicum), are a popular, non-starchy horticultural crop that contain health-promoting compounds such as carotenoids (e.g. lycopene and β-carotene). Among the carotenoids in tomatoes, lycopene has been extensively studied, and its effectiveness in reducing the risk of various diseases has been well-documented. Lycopene is a C₄₀ tetraterpenoid comprising 11 conjugated and two non-conjugated double bonds, and it naturally exists in cis and trans isomeric configurations.

While the all-trans isomer is prevalent and stable in fresh tomatoes, cis-isomers are more bioavailable, contributing more than half of the lycopene in human serum and tissues, with potential health benefits, including reducing oxidative stress, inflammation and the risk of degenerative diseases, such as cardiovascular diseases and certain cancers. Carotenoid levels in tomatoes are tissue-specific and influenced by multiple factors, including their growth environment. For example, field-cultivated tomatoes have been reported to have a higher lycopene content as compared to greenhouse-cultivated tomatoes (Raiola et al., 2014). Moreover, tomatoes grown in greenhouses often have lower levels of certain phytochemicals, such as antioxidants, carotenoids, and volatile compounds.

At the same time, the increasing demand for fresh tomatoes year-round, changing environmental conditions, and rising consumer preferences have significantly enhanced the need for controlled environment-grown greenhouse tomato fruit. Furthermore, the majority of tomatoes in the United States are cultivated in controlled environments. Therefore, a continuing need exists in the art to develop methods to enhance overall carotenoid content in tomatoes, including the most bioavailable form of lycopene, cis-lycopene.

### SUMMARY OF THE INVENTION

In one aspect, the invention provides a method for increasing lycopene content in a tomato plant, the method comprising: (a) obtaining a plant; and (b) treating the plant with blue light, UV-B light, or a combination thereof, to induce accumulation of lycopene in said plant. In certain embodiments, said lycopene comprises all-trans-lycopene, 5-cis-lycopene, 9-cis-lycopene, 13-cis-lycopene, or a combination of any thereof. In specific embodiments, said lycopene comprises 5-cis-lycopene. In some embodiments, said treating increases the ratio of lycopene cis-isomers to trans-isomers as compared to a control plant lacking said treatment. In further embodiments, said treating is carried out at the beginning of the reproductive phase; or after development of a tomato fruit. In some embodiments, said treating is carried out in the presence of visible light. In other embodiments, the method comprises growing the plant under blue light, UV-B light, or a combination thereof. In particular embodiments, the plant is treated with blue light and UV-B light. In yet other embodiments, the plant is treated for about 1 hr, 2 hr, 3 hr, 4 hr, 5 hr, 6 hr, 7 hr, 8 hr, 9 hr, or 10 hr per day. In one embodiment, the plant is treated with UV-B light for about 4 hr per day. In another embodiments, the plant is treated with blue light for about 8 hr per day.

In other embodiments, the methods provided herein increases the lycopene content in the plant by about 5%, 10%, 20%, 30%, 40%, 50%, 60%, 70%, 80%, 90%, 100%, 150%, 175%, 200%, 225%, 250%, or 300% as compared to a control plant lacking said treatment. In further embodiments, treating the plant is carried out in a controlled environment. In certain embodiments, the light is applied continuously; non-continuously; or is applied from about 1 hr to about 24 hr per day. In further embodiments, the blue light comprises an intensity of about 100 μmol m⁻² s⁻¹ to about 300 μmol m⁻² s⁻¹; or the UV-B light comprises an intensity of about 1 μmol m⁻² s⁻¹ to about 10 μmol m⁻² s⁻¹. In still further embodiments, the lycopene content in the plant is increased about 1.1-fold, 1.2-fold, 1.3-fold, 1.4-fold, 1.5-fold, 1.6-fold, 1.7-fold, 1.8-fold, 1.9-fold, 2.0-fold, 2.1-fold, 2.2-fold, 2.3-fold, 2.4-fold, 2.5-fold, 2.6-fold, 2.7-fold, 2.8-fold, 2.9-fold, or 3.0-fold as compared to a control plant lacking said treatment. In certain embodiments, treating the plant increases β-carotene content in the plant.

In another aspect, a method of increasing the nutritional content of a tomato is provided. In one embodiment, the method comprises obtaining a plant; and treating the plant with blue light; wherein said treating induces the conversion of trans-lycopene to cis-lycopene in the plant. In some embodiments, the cis-lycopene comprises 5-cis-lycopene, 9-cis-lycopene, 13-cis-lycopene, or a combination of any thereof. In other embodiments, the cis-lycopene content in the plant is increased about 1.1-fold, 1.2-fold, 1.3-fold, 1.4-fold, 1.5-fold, 1.6-fold, 1.7-fold, 1.8-fold, 1.9-fold, 2.0-fold, 2.1-fold, 2.2-fold, 2.3-fold, 2.4-fold, 2.5-fold, 2.6-fold, 2.7-fold, 2.8-fold, 2.9-fold, or 3.0-fold as compared to a control plant lacking said treatment. In further embodiments, the plant is treated for about 1 hr, 2 hr, 3 hr, 4 hr, 5 hr, 6 hr, 7 hr, 8 hr, 9 hr, or 10 hr per day.

In still yet another aspect, a method of increasing β-carotene content in a tomato, the method comprising: (a) obtaining a plant; and (b) treating the plant with UV-B light; wherein said treating increases β-carotene content in the plant. In some embodiments, said treating is carried out in a controlled environment. In other embodiments, the plant is treated for about 1 hr, 2 hr, 3 hr, 4 hr, 5 hr, 6 hr, 7 hr, 8 hr, 9 hr, or 10 hr per day.

### BRIEF DESCRIPTION OF THE DRAWINGS

FIG. 1: Shows representative chromatograms of different carotenoid compounds obtained from the tomato samples grown under different supplemental lighting conditions. lutein (a); β-carotene (b); 13-cis-lycopene (c); 9-cis-lycopene (d); all-trans-lycopene (c); 5-cis-lycopene (f).

FIG. 2: Shows bar graphs of all-trans-lycopene (Panel A); 5-cis-lycopene (Panel B); 9-cis-lycopene (Panel C); and 13-cis-lycopene (Panel D) contents in two tomato varieties (Plum Regal and TAM Hot-Ty) under different pre-harvest light exposures (Blue, Blue+UV-B, UV-B, and Control). Different lower-case letters indicate significant differences between light treatments between the varieties based on Tukey's HSD test (P≤0.05). Each bar represents mean±standard error values.

FIG. 3: Shows bar graphs of total cis-lycopene (Panel A); cis: trans-lycopene (Panel B); β-carotene (Panel C); and Lutein (Panel D) contents in two tomato varieties (Plum Regal and TAM Hot-Ty) under different pre-harvest light exposures (Blue, Blue+UV-B, UV-B and control). Different small letters indicate significant differences between light treatments between the varieties based on Tukey HSD test (P≤0.05). Each bar represents mean±standard error values.

FIG. 4: Shows a PLS-DA Score plot and VIP scores for TAM Hot-Ty (Panels A & B) and Plum Regal (Panels C & D).

FIG. 5: Shows a heat map based on the scaled values of the measured compounds obtained under exposure to four different light treatments: Blue, Blue+UV-B, UV-B, and Control. Light treatments are clustered based on their measured variables, and variables are clustered based on their correlation. Cells with darker colors have high and low relative expression, respectively. In particular, the concentration of trans- and cis-lycopene is higher than that of the control under all the lighting treatments, with the highest enhancement under the blue light treatment. UV-B enhanced β-carotene and lutein content, and the combination treatment shows a nullifying effect of each of the individual light treatments. The abundance of cis-lycopene in comparison to trans-lycopene also increased the most under blue light treatment.

FIG. 6: Shows a proposed model of trans-to-cis isomerization of lycopene.

### DETAILED DESCRIPTION

Tomato fruit, being climacteric, ripens at the end of maturity when fruits (in red/orange varieties) undergo physiological and biochemical changes that transform the green tomato fruit into an attractive, brightly colored nutritious fruit (Quinet et al., 2019). This transition is due to the accumulation of carotenoids, mainly lycopene and carotenes, and a decline in β-xanthophylls and chlorophylls (Su et al., 2015; Bramley, 2002). Indeed, during ripening, the concentration of carotenoids in tomatoes increases between 10- and 14-fold (Fraser et al., 1994). The accumulation of carotenoids could protect the fruit from oxidative damage, as ripening is an oxidative process, and carotenoids are potent natural antioxidants (Jha et al., 2024).

The main carotenoids in tomatoes are lycopene, α-carotene, β-carotene, γ-carotene, ξ-carotene, ζ-carotene, phytoene, phytofluene, cyclolycopene, neurosporene, lutein, violaxanthin, neoxanthin, zeaxanthin, α-cryptoxanthin, and β-cryptoxanthin (Tchonkouang et al., 2022). The most abundant carotenoids in red tomato fruits are lycopene (90% of total carotenoids), β-carotene (5%-10%), and lutein (<1%), with lycopene and β-carotene mainly contributing to the characteristic red color of tomato fruit (Tchonkouang et al., 2022; Setyorini, 2021).

Lycopene is a bright red carotenoid pigment that is present in tomatoes and other red fruits and vegetables like carrots, watermelons, and papaya but notably absent in strawberries, red bell peppers, or cherries (Ray et al., 2021). Lycopene does not have provitamin A activity, but it does have strong antioxidant properties. It is twice as effective as β-carotene at neutralizing singlet oxygen and can have up to ten times the antioxidant activity of α-tocopherol (Tanumihardjo et al., 2005). Lycopene is a C₄₀ tetraterpenoid comprising 11 conjugated and two non-conjugated double bonds, and it naturally exists in cis and trans isomeric configurations. However, red tomatoes primarily contain the all-trans isoform (almost 90%), often referred to as all-E-lycopene, with the remaining 10% being cis/z-isomeric forms (mainly 5Z, 9Z, and 13Z) (Yasmeen et al., 2022).

Even though trans-lycopene is the most common form, cis-lycopene has greater bioavailability and higher thermodynamic stability, accounting for 58%-73% of total lycopene in human serum due to its preferential absorption (Clinton et al., 1996). The possible reason for the higher bioavailability of cis-forms may be attributed to the higher polarity, shorter length, and being less prone to aggregation due to their kinked forms than their all-trans counterparts (Fraser et al., 1994; Shi et al., 2000). Moreover, it has also been shown that cis-isomers are present in a lipid-dissolved globular structure in chromoplasts and, therefore, have higher solubility compared to their trans-isomer counterparts, which are found in crystalline structures (Cooperstone et al., 2015)

In vivo studies have confirmed the anti-cancer activities of lycopene, particularly in prostate cancer. Human and animal studies have confirmed the influence of lycopene on some hallmarks of cancer; and lycopene currently presents a very promising natural compound in the prevention and treatment of Non-Alcoholic Fatty Liver disease (NAFLD). Production of tomato fruits having increased lycopene content, and lycopene cis-isomers in particular, would be advantageous. Although specific physical and chemical processes have been used to induce the in vitro isomeric transition of lycopene from trans to cis isoforms, no methods currently exist to augment the levels of cis-isomers of lycopene along with other carotenoids in the whole tomato fruit. Furthermore, the in-vitro conversion of cis-lycopene is often associated with a reduction in beta-carotene and overall trans-lycopene. In contrast, the present disclosure provides for the first time methods for significantly enhancing the levels of cis-isoforms of lycopene, along with other carotenoids such as trans-lycopene and beta-carotene. Therefore, the methods described herein overcome the limitations of in vitro conversion and present a promising approach for delivering high levels of health-promoting carotenoids compared to methods known in the art.

The present disclosure overcomes the limitations of the prior art by providing methods for increasing carotenoid content in a tomato plant, the method comprising obtaining a plant; and treating the plant with blue light, UV-B light, or a combination thereof, to induce accumulation of carotenoids in said plant. In some embodiments, the carotenoid is selected from the group consisting of β-carotene, all-trans-lycopene, 5-cis-lycopene, 9-cis-lycopene, 13-cis-lycopene, or a combination of any thereof. In particular, the present disclosure demonstrates that when blue light, UV-B light, or a combination thereof is applied to a tomato plant, the levels of cis-lycopene and other carotenoids in tomato fruits can be increased by 2-3-fold across germplasms yielding significant improvements toward increasing the nutritional content of whole tomato fruit. The present disclosure further demonstrates methods for increasing the conversion of trans-lycopene to cis-lycopene in whole fruit by supplementing with UV-B, blue, and their combination for the first time.

In particular embodiments, UV-B light effectively upregulated levels of carotenoids, including the most desired 5-cis-lycopene. In further embodiments, the combination of UV-B and blue light enhanced their levels by 2-3-fold in harvested tomato fruit. Moreover, co-irradiation with UV-B and blue light is shown to display a synergistic effect on the induction of both trans- and cis-lycopene levels in tomato fruit. The ability to produce these desirable effects using the methods described herein offers unique benefits not otherwise available in the art; and enables controlled environmental conditions that significantly increase the nutritional content of whole tomato fruit.

The embodiments described herein therefore relate to methods for increasing lycopene content in a tomato plant by treating the plant with blue light, UV-B light, or a combination thereof, to induce accumulation of lycopene in said plant. Also described are methods for inducing the conversion of trans-lycopene to cis-lycopene in the plant by treating the plant with blue light; or increasing β-carotene content by treating the plant with UV-B light. In certain applications, a blue light treatment, a UV-B light treatment, or a combination thereof, is provided to a plant at the reproductive phase. In some embodiments, such light treatment is carried out when the plant is from about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75 days following flower formation. In specific embodiments, the light treatments of the present invention can be carried out during or following development of at least a first tomato fruit to enhance carotenoid accumulation and lycopene content, as compared to an appropriate control plant lacking said treatment. Such light treatments can be continuous or non-continuous.

Several embodiments of the invention relate to a method comprising obtaining a plant; and treating the plant with blue light, UV-B light, or a combination thereof, to induce accumulation of lycopene in said plant. Treating the plant with blue light and/or UV-B light can by carried out at a range of temperatures. For example, treating can be carried out at a temperature of about 20° C., 21° C., 22° C., 23° C., 24° C., 25° C., 26° C., 27° C., 28° C., 29° C., 30° C., 31° C., 32° C., 33° C., or 34° C. In specific embodiments, treating can be carried out at a temperature between about from 25° C. and about 30° C. As described herein, such light treatment can be carried out at one of such temperatures or between such temperatures until fruits of the plant mature.

Several embodiments of the invention further relate to growing the plant under blue light and/or UV-B light. In specific embodiments, the blue light and/or UV-B light is further defined as supplemental light. Growing the plant under blue light and/or UV-B light as described herein can increase carotenoid content in a plant, including but not limited to, increasing β-carotene, all-trans-lycopene, 5-cis-lycopene, 9-cis-lycopene, 13-cis-lycopene, or a combination of any thereof. Growing the plants according to the methods described herein may also be carried out under a photoperiod of about 16 hr, 17 hr, 18 hr, 19 hr, 20 hr, 21 hr, 22 hr, 23 hr, or 24 hr. In particular embodiments, the methods may be carried out under a photoperiod of about 16 hr.

Blue light has a wavelength of approximately 400 nm to 500 nm with a peak wavelength at 444 nm, whereas UV-B light has a wavelength of approximately 280 to 315 nm with a peak wavelength at 310 nm.

The methods for carotenoid content provided herein include treating plants continuously with blue light and/or UV-B light or non-continuously with blue light and/or UV-B light. For example, in some embodiments the blue light and/or UV-B light is applied to the plant for about 1, 2, 3, 4, 5, 6, 7, 8, 9, 10, 11, 12, 13, 14, 15, 16, 17, 18, 19, 20, 21, 22, 23, or 24 hr per day. In specific embodiments, the blue light and/or UV-B light is applied to the plant from between about 4 hr to about 8 hr per day. In addition, light treatments of the present invention can be carried out in the presence of visible light or in the presence of a range of wavelengths within the visible spectrum or in the presence of sources of photosynthetic active radiation. In certain embodiments, the supplemental UV-B light intensity may be provided up to about 1 μmoles/m²·s, 2 μmoles/m²·s, 3 μmoles/m²·s, 4 μmoles/m²·s, or 5 μmoles/m²·s. In further embodiments, the supplemental blue light intensity may be provided up to about 100 μmoles/m²·s, 150 μmoles/m²·s, 200 μmoles/m²·s, 210 μmoles/m²·s, 220 μmoles/m²·s, 230 μmoles/m²·s, or 240 μmoles/m²·s.

Sources for applying blue light and/or UV-B light are known in the art. See, e.g. Filippos Bantis, et al. Current status and recent achievements in the field of horticulture with the use of light-emitting diodes (LEDs). Scientia Horticulturae, Volume 235; 437-451 (2018). For example, blue light and/or UV-B light may be provided to the plants with the use of artificial lights. Non-limiting examples of artificial lighting include, the use of a 1000-watt metal halide portable light tower placed over the plants. Other types of light, such as high-pressure sodium or LED, may be provided, as well. In some embodiments, blue light and/or UV-B light treatment conditions may be provided to a field-grown plant by exposing the field-grown plant to artificial light.

Some embodiments described herein relate to increasing carotenoid content, e.g. lycopene content, in the plant by at least about 5%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 175%, 200%, 210% 225%, 250%, 275%, or 300%. In specific embodiments, the carotenoid content in a plant may be increased by at least about 45%, 46%, 47%, 48%, 49%, or 50%, as compared to a control plant lacking a light treatment described herein. In other embodiments, the plant may be treated with blue light and/or UV-B light to increase carotenoid content, e.g. lycopene content, in the plant by at least about 1.48-fold, 1.2-fold, 1.3-fold, 1.4-fold, 1.5-fold, 1.6-fold, 1.7-fold, 1.8-fold, 1.9-fold, 2.0-fold, 2.1-fold, 2.2-fold, 2.3-fold, 2.4-fold, 2.5-fold, 2.6-fold, 2.7-fold, 2.8-fold, 2.9-fold, or 3.0-fold as compared to a control plant lacking said treatment. In particular embodiments, the carotenoid content in a plant may be increased by at least about 1.4-fold, 1.41-fold, 1.42-fold, 1.43-fold, 1.44-fold, 1.45-fold, 1.46-fold, 1.47-fold, 1.48-fold, 1.49-fold, or 1.5-fold, as compared to a control plant lacking said treatment. In specific embodiments, treating the plant with blue light and UV-B light synergistically increases carotenoid content in said plant, e.g. β-carotene, all-trans-lycopene, 5-cis-lycopene, 9-cis-lycopene, 13-cis-lycopene, or a combination of any thereof.

The methods described herein solve a variety of crop production concerns and can be utilized in the research and commercial phases of product development. For example, the nutritional content of a tomato can be increased when grown in a controlled environment such as a greenhouse as compared to a control plant lacking a light treatment described herein. The present disclosure enables the production of high-quality tomatoes with improved flavor and aroma, enriched with health-promoting compounds in greenhouse environments. Utilizing the methods described herein, it is possible to enhance carotenoid content in whole, fresh tomatoes especially in a controlled environment. It is also possible to apply the methods described herein to a wide range of plant growth paradigms and to improve operational efficiency and flexibility. This provides case in plant crop production by enabling breeders to produce plants with significantly improved nutritional content, that would normally not be possible. The ability to increase carotenoid content in a plant as described herein, e.g. in a tomato plant, provides a means to overcome commercially relevant limitations in growing tomato plants in controlled environments.

Plants useful in accordance with the present invention may include, but are not limited to, tomato, grapefruit, watermelons, guava, red cabbage, persimmon, and papaya. In specific embodiments, the plant may be a tomato plant.

The following definitions are provided to define and clarify the meaning of these terms in reference to the relevant embodiments of the present disclosure as used herein and to guide those of ordinary skill in the art in understanding the present disclosure. Unless otherwise noted, terms are to be understood according to their conventional meaning and usage in the relevant art, particularly in the field of molecular biology, plant development, and plant transformation.

When introducing elements of the present disclosure or the embodiment(s) thereof, the articles “a”, “an”, “the”, and “said” are intended to mean that there are one or more of the elements.

The term “and/or”, when used in a list of two or more items, means any one of the items, any combination of the items, or all of the items with which this term is associated.

The terms “comprising”, “including”, and “having” are intended to be inclusive and mean that there may be additional elements other than the listed elements. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

As used herein, a “plant” may refer to a whole plant, explant, plant part, seedling, or plantlet at any stage of regeneration or development.

As used herein, the term “photoperiod” means the duration of light exposure in a 24-hour period.

As used herein, the term “blue light” describes light having a wavelength between 400 nm to 500 nm. For example, light at a wavelength of 444 nm.

As used herein, the term “UV-B light” has a wavelength of approximately 280 to 315 nm. For example, light at a wavelength of 310 nm.

As used herein, “reproductive phase” can refer to starting of a plant's flower development.

As understood in the art, “fruit maturation” is a key period in a plant's lifecycle. For tomatoes, the stages occurring during maturation include green mature stage, breaker stage, turning stage, pink stage, light red stage, and red and final stage.

As used herein, “synergistic” or “synergistically” refers to a combination of two growth conditions, e.g. blue light and UV-B light treatment.

As used herein, the term “isogenic” means genetically uniform, whereas non-isogenic means genetically distinct.

All methods described herein can be performed in any suitable order unless otherwise indicated herein or clearly contradicted by context. The use of any and all examples, or exemplary language (e.g., “such as”) provided with respect to certain embodiments herein is intended merely to illuminate the present disclosure and does not pose a limitation on the scope of the present disclosure otherwise claimed.

### EXAMPLES

### Example 1. Materials and Methods

Reagents: The standards for β-carotene (purity≥97%), lutein (purity≥96%), and trans-lycopene (purity≥98%) were purchased from Sigma-Aldrich (St. Louis, MO, USA). HPLC-grade methanol and methyl tert-butyl ether (MTBE) were purchased from Sigma-Aldrich (St. Louis, MO, USA).

Plant materials and growth conditions: The two tomato varieties, Plum Regal (PR, commercial) and TAM-Hot-Ty (THT, developed by Dr. Kevin Crosby at Texas A&M University), were grown in the greenhouse located at the Southern Crop Improvement Greenhouse Facility at Texas A&M University, College Station, TX. The seeds were sown in polystyrene 200-cell trays (each cell measured 2.5×2.5×7.6 cm; Speedling, Ruskin, FL, USA) filled with media, consisting of 90% sphagnum peat moss and 10% perlite, and vermiculite. The trays were saturated with water, incubated in darkness at 25° C. for two days, and transferred to the greenhouse. The trays were uniformly irrigated daily. At the four true leaf stages, seedlings were transplanted to 10-gallon pots filled with potting media (Sunshine Mix #4, Sun Gro Horticulture, MA, USA) and transferred to the greenhouse. Plants were uniformly watered once daily and fertigated twice a week with 100 ppm of N using 20:20:20 NPK until the flowering stage. At the start of the reproductive phase, they were fertigated twice a week with Masterblend fertilizer (4-18-38 NPK), calcium nitrate, and Epsom salt as per the manufacturer's recommendations. The plants were then exposed to one of the four light treatments: 1. Blue light (238 μmol m⁻²·s⁻¹ at 40 cm from plants for 8 h), 2. UV-B light (5 μmol m⁻²·s⁻¹ at 46 cm from plant for 4 h), 3. Blue+UV-B (1 and 2 combined) or 4. control (no supplemental light). The dose for the lighting treatments was decided based on the difference in the natural solar spectrum outside and inside the greenhouse. Four replications per variety for each light treatment were evaluated in a completely randomized design. Plants were spaced at 1.5 ft×1.5 ft with a total experimental area of 162 sq ft.

Carotenoid Analysis: The extraction of carotenoids from tomato samples was carried out as described by Singh et al. (2021) with slight modifications. Briefly, tomato puree (5 g) was extracted with 5 mL of extraction solvent (1:1 chloroform:acetone, v/v) by homogenization for 30 sec, sonication for 15 min in ice-cold water, and centrifugation at 3900 rpm for 16 min. The supernatant was separated, and the remaining residue was re-extracted using 5 mL of solvent. The supernatant collected was pooled, filtered using a 0.45 μm PTFE filter, and used for UHPLC analysis.

To identify and quantify carotenoids, the extract (5 L) was injected into Agilent UHPLC (Milford, MA, USA) with a YMC C30 column (50 mm length×2.0 mm internal diameter, 3 μm particle size, YMC Europe, Dinslaken, Germany). The gradient mobile phases of methanol (D) and MTBE (C) with a flow rate of 0.8 mL/min were used for the separation of carotenoids. The gradient program was set as follows: 0 min: 15% C; 0.5 min 15% C; 1.5 min 35% C; 3 min 50% C; 4.5 min 80% C; 9.0 min: 80% C; 11 min 15% C. The column temperature was maintained at 25° C. The diode-array detection (DAD) signals for detection were 471 nm, 450 nm, 350 nm, and 286 nm.

The mass spectral (MS) analysis of carotenoid compounds in the tomato samples was carried out by ultra-performance liquid chromatography (UHPLC, Agilent 1290 system, Waldbronn, Germany) coupled to atmospheric pressure chemical ionization and quadrupole time-of-flight mass spectrometry (APCI-QTOFMS, Maxis Impact, Bruker Daltonics, Billerica, MA) (Lee et al., 2020; Singh et al., 2021). Briefly, carotenoids from tomato samples were separated on the YMC C30 column (50 mm length×2.0 mm internal diameter, 3 μm particle size, YMC Europe, Dinslaken, Germany) using gradient mobile phase of methanol (A) and MTBE (B) with 0.35 mL/min flow rate. The gradient program was set as follows: 0 to 5 min, 98% A; 5 to 10 min, 98 to 55% A; 10 to 18 min, 55% A; 18 to 21 min, 50% A; 21 to 23 min, 20% A, 23 to 25 min, 20% A, 25 to 26 min, 98% A. MS analysis carried out on a maXis impact mass spectrometer (Bruker Daltonics, Billerica, MA) using atmospheric pressure chemical ionization in positive ionization mode. Full scan MS and total ion chromatogram data acquisition was performed at m/z 50-2000. Nitrogen was used as a nebulizer and drying gas. The parameters of the mass spectrometer were as follows: capillary voltage, 2500 V; collision energy, 10 eV; nebulizer gas flow, 4.0 L/min; nebulizer gas pressure, 1.6 bar; transfer time of the source, 120 μs; prepulse storage time, 8 μs; capillary temperature, 200° C.; vaporizer temperature, 400° C. Data Analysis 4.3 software (Bruker Daltonics) was used to process raw data, and the mass data was exported to Profile Analysis 1.1 (Bruker Daltonics) for data processing. The UV-Vis scanning spectra were recorded from 200 to 800 nm. The compounds were identified by matching UV absorption at 471 nm, pseudo-molecular ion masses, and MS/MS fragmentation patterns with authentic standards and data reported in the literature (Lee et al., 2020). The concentrations of β-carotene and lycopene isomers were determined using the external calibration curve of their commercial standards. Results are expressed as μg of carotenoids per g fresh weight of tomato sample (μg/g FW).

The carotenoid concentration values were expressed as the average of biological replicates ±standard error (SE). The multiple means between treatments and varieties were compared using Tukey's Honestly Significant Difference (HSD) after a two-way analysis of variance (ANOVA) with R software. The datasets were subjected to chemometric analysis using supervised methods, i.e., partial least squares discriminant analysis (PLS-DA) on MetaboAnalyst 6.0 (Ewald et al., 2024).

### Example 2. Effects of Blue Light, UV-B Light, and Blue+UV-B Light Supplementation on Tomato Fruit Carotenoids

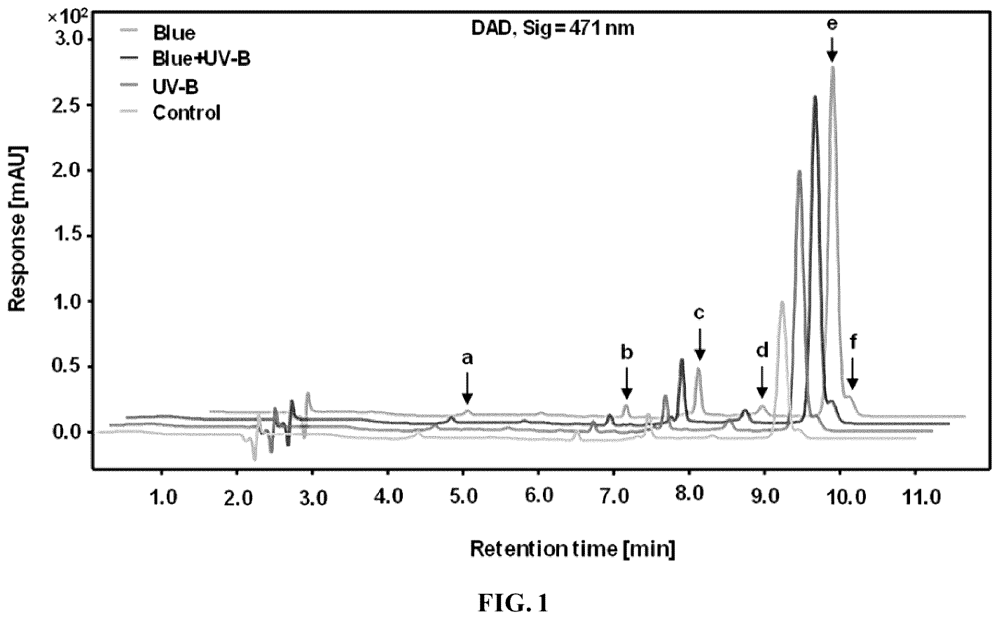

UHPLC was used to identify and measure the relevant carotenoids present in the tomato fruit as described in Example 1. The UHPLC analysis of tomato samples revealed peaks for six carotenoid compounds: lutein, β-carotene, 13-cis-lycopene, 9-cis-lycopene, all-trans-lycopene, and 5-cis-lycopene (FIG. 1). The absorbance peak area of each compound was used to calculate the accumulation of these compounds and determine any changes due to the supplemental lighting.

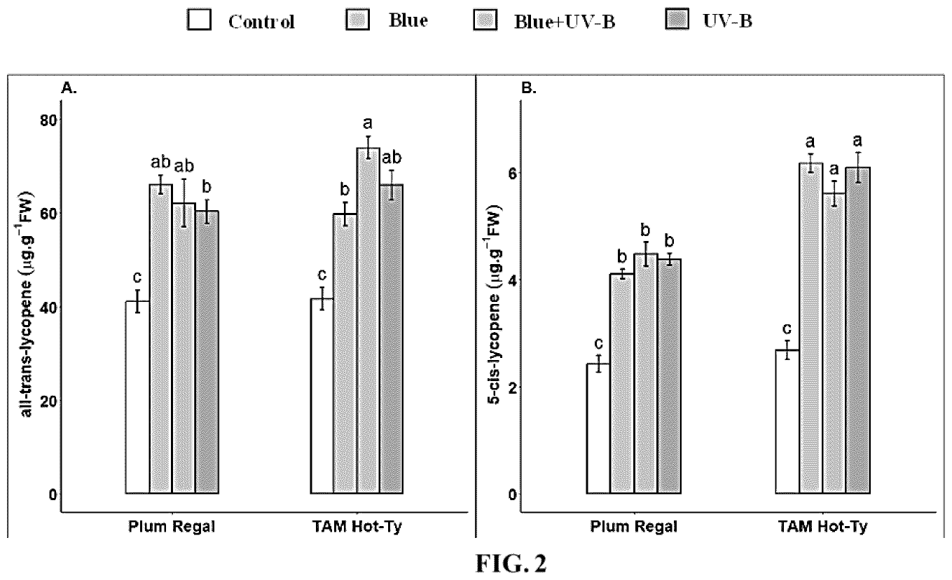

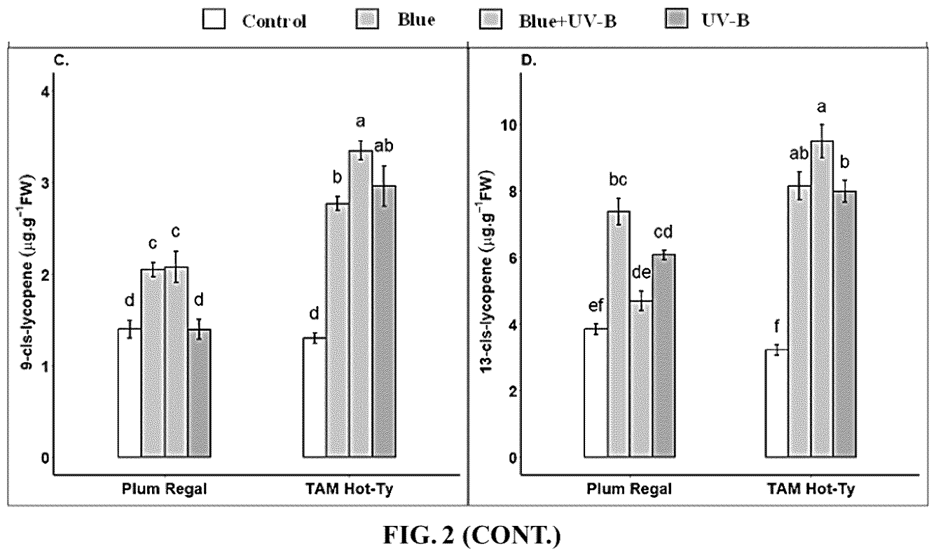

The exposure of tomato plants to blue, UV-B, or the combination of blue and UV-B was associated with a significant (P≤0.05) increase in all-trans-lycopene in tomato, including both Plum Regal (PR) and TAM-Hot-Ty (THT) varieties (FIG. 2; Panel A). In the case of PR, all-trans-lycopene levels were moderately higher than the control, and the enhancement was from 41.1 μg·g⁻¹ to 66.0 μg·g⁻¹ for blue, 62.1 μg·g⁻¹ in blue+UV-B and 60.3 μg·g⁻¹ in UV-B, i.e., 1.6, 1.5, and 1.5 folds, respectively, as compared to appropriate control plants. Similar to PR, the levels of all-trans-lycopene in THT were also moderately higher than control, by 1.4, 1.8, and 1.6 fold compared to the control value (41.6 μg·g⁻¹) in plants supplemented with blue, blue+UV-B and UV-B light, i.e., 59.7 μg·g⁻¹, 74.0 μg·g⁻¹, and 66.0 μg·g⁻¹, respectively.

A similar trend was observed for 5-cis-lycopene under the different light treatments, with THT exhibiting a higher increase compared to PR (FIG. 2; Panel B). Specifically, exposure to blue light enhanced the levels of 5-cis-lycopene to 6.2 μg·g⁻¹ and 4.1 μg·g⁻¹. i.e., 2.3 and 1.7 fold in comparison to control for THT (2.7 μg·g⁻¹) and PR (2.4 μg·g⁻¹), respectively. Similarly, UV-B light exposure significantly (P≤0.05) enhanced the levels of 5-cis-lycopene content to 2.3 μg·g⁻¹. which is 2.3 fold higher compared to the control value in THT. In PR, 5-cis-lycopene increased to 4.4 μg·g⁻¹, which was 1.8 fold higher than the control value. Under the combination of blue and UV-B light, 5-cis-lycopene content increased to 5.6 μg·g⁻¹ and 4.5 μg·g⁻¹, which is 2.1 and 1.9 fold higher than the control for THT and PR, respectively.

The concentrations of 9-cis-lycopene significantly (P≤0.05) increased under all supplemental lighting conditions in THT; however, only blue and a combination of blue and UV-B treatments were effective in enhancing their levels in PR (FIG. 2C). The blue light was effective in enhancing 9-cis-lycopene levels by 2.2 fold (2.8 μg·g⁻¹); however, UV-B individually enhanced their levels by 2.3-fold (3.0 μg·g⁻¹), and the combination of UV-B and blue resulted in enhancement by 2.6 fold (3.4 μg·g⁻¹) compared to the control value (1.3 μg·g⁻¹) in THT. Likewise, it was enhanced by about 1.5 fold in blue (2.04 μg·g⁻¹) and combination (2.08 μg·g⁻¹) treatments compared to the control (1.4 μg·g⁻¹).

When subjected to individual blue and UV-B light, the 13-cis-lycopene content in THT increased by 2.5 fold compared to the control value (3.2 μg·g⁻¹), whereas it increased to 3 fold under the combination treatment with the value of 9.49 μg·g⁻¹ (FIG. 2D). In the case of PR, the highest content of 13-cis-lycopene was observed in blue light (7.4 μg·g⁻¹), which was about 2 fold higher than the control value (3.8 μg·g⁻¹). UV-B exposure enhanced the level to 6.1 μg·g⁻¹ in PR, i.e., 1.6 fold higher compared to the control.

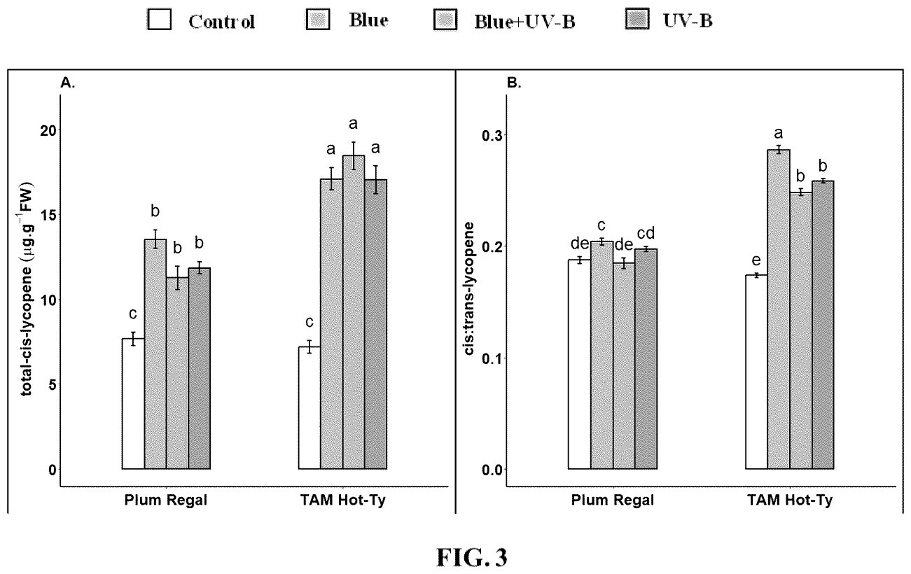

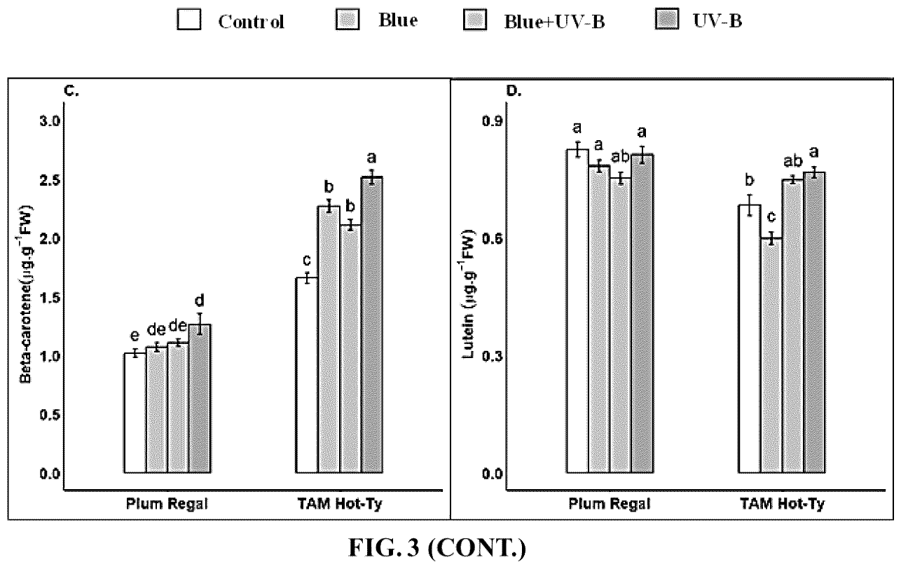

The total-cis-lycopene content in both varieties increased significantly (P≤0.05) due to the light treatments; moreover, substantially higher levels of total-cis-lycopene were observed in the THT variety compared with PR (FIG. 3A). In the PR, increases in cis-lycopene were 1.8, 1.5, and 1.6 compared to the control (7.7 μg·g⁻¹) for blue (13.5 μg·g⁻¹), blue+UV-B (11.3 μg·g⁻¹) and UV-B (11.9 μg·g⁻¹), respectively. However, in the case of THT, the levels of total-cis-lycopene increased 2.4, 2.6, and 2.4 fold compared to the control (7.2 μg·g⁻¹) with 17.1 μg·g⁻¹ in blue, 18.4 μg·g⁻¹ in blue+UV-B and 17.0 μg·g⁻¹ in UV-B, respectively. The ratio of total cis-lycopene to all-trans-lycopene increased under all the lighting treatments for THT, whereas, for PR, their levels increased significantly (P≤0.05) only under blue light (FIG. 3B). For both varieties, supplemental blue light was the most effective in increasing the abundance of cis-lycopene from that of control to 1.7 fold in THT and 1.1 fold in PR.

All the light treatments in THT significantly enhanced the β-carotene content, whereas only UV-B was effective in enhancing their levels in PR (FIG. 3C). The initial concentration of control in THT, i.e., 1.7 μg·g⁻¹ increased to 2.3 μg·g⁻¹ in blue, 2.1 μg·g⁻¹ in blue+UV-B and 2.5 μg·g⁻¹ in UV-B, 1.4, 1.3 and 1.5 fold differences compared to the control value. In PR, UV-B exposure resulted in the enhancement of β-carotene content from the control value of 1.0 μg·g⁻¹ to 1.3 μg·g⁻¹, i.e., 1.2 fold higher than the control value. Notably, UV-B was the most effective treatment in enhancing β-carotene levels in both varieties. The lutein content was not affected by supplemental lights in PR (FIG. 3D). However, UV-B exposure in THT enhanced its level to 0.8 μg·g⁻¹, which is 1.1 fold higher than the control.

These findings demonstrate that the exposure of tomato plants to blue light consistently enhances all-trans-lycopene, 5-cis-lycopene, 9-cis-lycopene, and 13-cis-lycopene in tomato, including both varieties tested (FIG. 1). The ratio of cis-isomers compared to trans-isomers also appeared to be significantly enhanced by blue light. Although the blue light-induced accumulation of lycopene was moderately high in both the tomato genotypes compared to their control values, the overall abundance of lycopene was much higher in THT than that of PR. In addition to enhancing lycopene biosynthesis, these results also confirm the effectiveness of blue light in augmenting the levels of cis-isomers of lycopene in tomato fruit. Furthermore, it should also be noted that while some variation was observed between the PR and THT varieties, the enhancement all-trans-lycopene, 5-cis-lycopene, 9-cis-lycopene, and 13-cis-lycopene using blue light was variety-independent.

Regarding UV-B light, these results demonstrate that supplemental UV-B significantly (P≤0.05) enhances lycopene levels in tomato. However, the degree of enhancement differed between genotypes, with THT showing significantly higher levels compared to PR. It is noteworthy that UV-B-induced total lycopene levels were either comparable to or slightly higher than those induced by blue light. Furthermore, combined exposure to UV-B and blue light significantly enhanced the levels of both trans- and cis-lycopene levels in both cultivars of tomato fruit (FIG. 2).

Based on the results described herein, co-irradiation may significantly enhance the induction of antioxidant-related gene expression and secondary metabolism in tomato fruit, resulting in a relatively higher abundance of carotenoids, especially the cis-isoforms of lycopene. Additionally, co-irradiation may potentially generate more severe oxidative pressure compared to their individual intensities, resulting in not only the activation of antioxidant machinery by accumulating antioxidant compounds, including lycopene but also enhancing the activities of carotenoid isomerase and lycopene-β-cyclase resulting in a higher abundance of cis-isoforms of lycopene and β-carotene in treated tomatoes.

### Example 3. ANOVA and Multivariate Analysis of Carotenoid Data

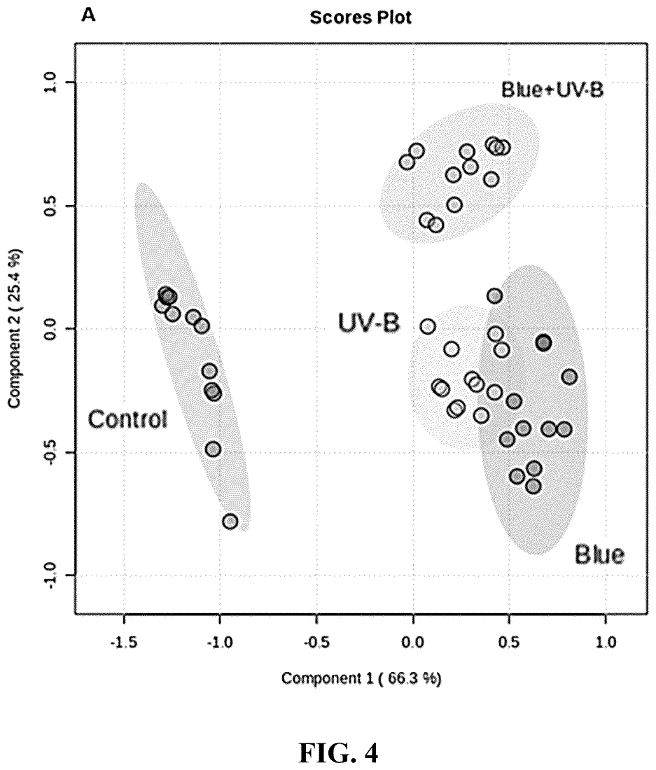

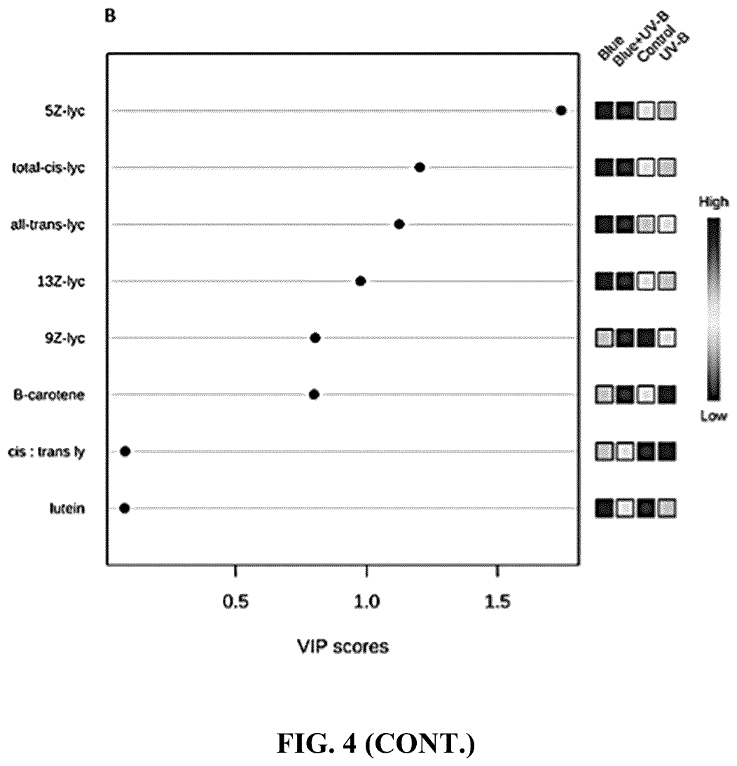

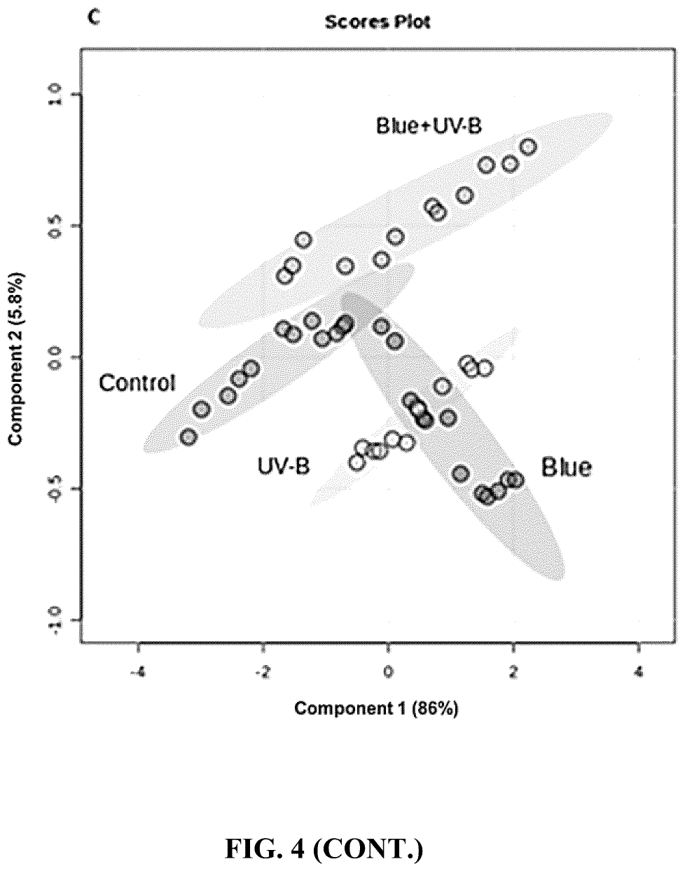

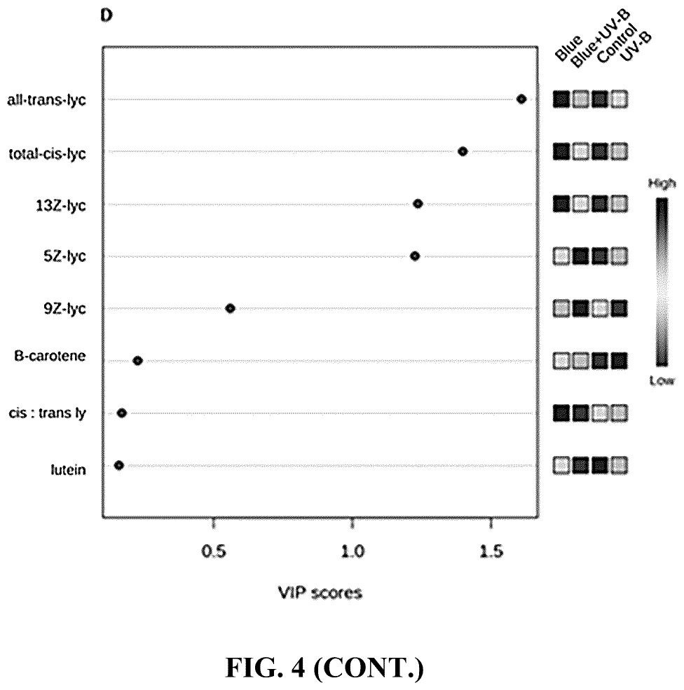

ANOVA revealed a significant individual as well as an interaction effect of variety and light treatments for all the assessed parameters (Table 1). Since the significant interaction effect denotes the differential response of the varieties to the light exposure treatments, i.e., G×E interaction, the mean comparison was conducted between treatments between varieties. Multivariate analysis of carotenoid data was performed to determine the variance and discriminant features between the light treatments in each variety using partial least squares-discriminant analysis (PLS-DA). The score plots between Component 1 and Component 2 of the three PLS-DA models are shown in (FIG. 4). Four clusters of PLS-DA models defined light treatments in each variety. The R² and Q² values were created using the “Leave one out” cross-validation method to evaluate the goodness of fit and prediction ability of three PLS-DA models. The first and second components of the score plot described around 90% variation in the different light groups for both models. Furthermore, the variable importance on projection (VIP) score plots was derived for the first component of each PLS-DA model (FIG. 4). The compounds responsible for clustering in two varieties were identified based on their VIP scores exceeding 1.0. The VIP score plots showed that total-cis-lycopene, all-trans-lycopene, 5-cis-lycopene, and 13-cis-lycopene consistently had VIP scores greater than 1.0. Among them, total-cis-lycopene, all-trans-lycopene, and 13-cis-lycopene were consistently higher under blue light treatment.

TABLE 1
Analysis of variance (ANOVA) of different carotenoids as
influenced by varieties (Var) and light treatments (Trt).

| | Variable | Source of variation | Pr(>F) | Significance |
|---|---|---|---|---|
| 1 | lutein | Var | 4.75E−11 | *** |
| | | Trt | 5.01E−06 | *** |
| | | Var × Trt | 2.67E−06 | *** |
| 2 | all-trans-lycopene | Var | 0.1653 | NS |
| | | Trt | 2.31E−14 | *** |
| | | Var × Trt | 1.99E−02 | * |
| 3 | 5-cis-lycopene | Var | 1.75E−15 | *** |
| | | Trt | <2E−16 | *** |
| | | Var × Trt | 4.11E−05 | *** |
| 4 | 13-cis-lycopene | Var | 6.49E−11 | *** |
| | | Trt | <2E−16 | *** |
| | | Var × Trt | 8.28E−12 | *** |
| 5 | 9-cis-lycopene | Var | 1.02E−15 | *** |
| | | Trt | <2E−16 | *** |
| | | Var × Trt | 8.17E−09 | *** |
| 6 | total-cis-lycopene | Var | 5.56E−14 | *** |
| | | Trt | <2E−16 | *** |
| | | Var × Trt | 1.41E−07 | *** |
| 7 | cis:trans-lycopene | Var | <2E−16 | *** |
| | | Trt | <2E−16 | *** |
| | | Var × Trt | <2E−16 | *** |
| 8 | β-carotene | Var | <2E−16 | *** |
| | | Trt | 5.33E−16 | *** |
| | | Var × Trt | 9.80E−08 | *** |

Significance codes:
‘***’ 0.001;
‘**’ 0.01;
‘*’ 0.05;
‘.’ 0.1

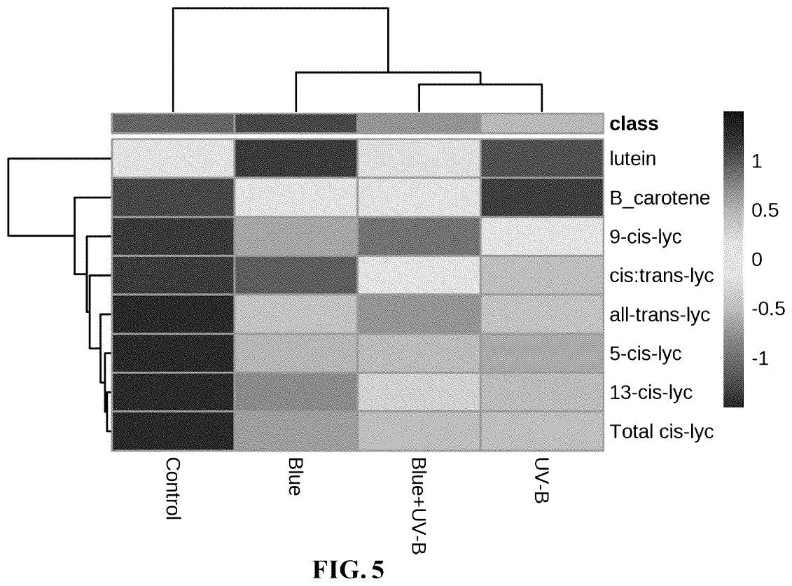

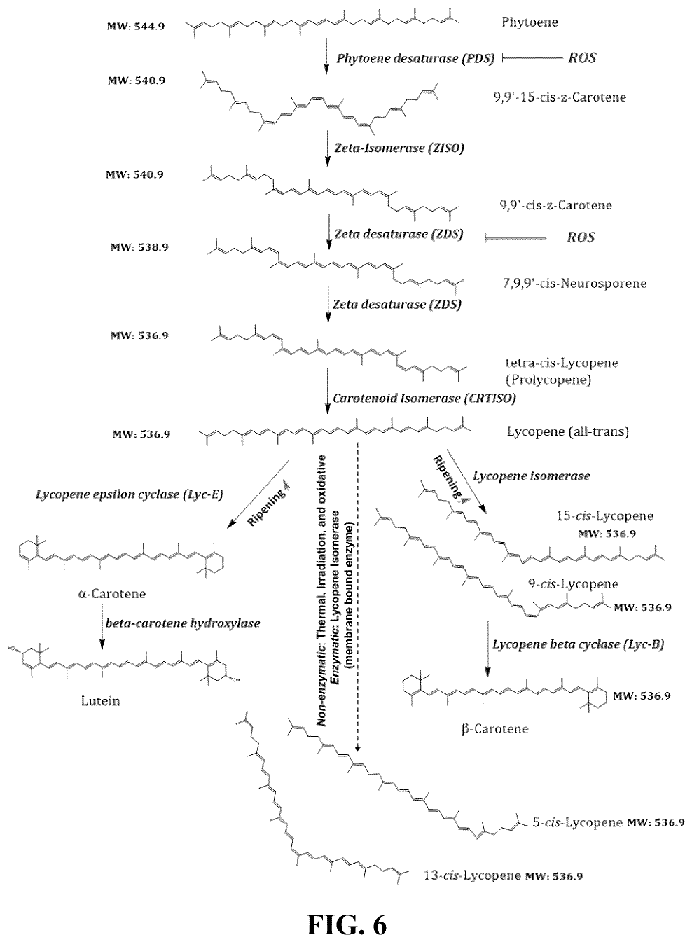

A heat map was constructed using the pooled data from all varieties, which confirmed the results from each VIP score (FIG. 5). The concentration of trans- and cis-lycopene was higher than that of the control under all the lighting treatments, with the highest enhancement under the blue light treatment. UV-B enhanced β-carotene and lutein content, and the combination treatment showed a nullifying effect of each of the individual light treatments. It is important to note that the abundance of cis-lycopene in comparison to trans-lycopene also increased the most under blue light treatment.

### Example 4. Evaluation of Photoperiod, Intensity, and Duration of Exposure to Blue and UV-B Light

The results described herein demonstrate modulation of tomato fruit carotenoids under supplemental blue and UV-B lighting. Light treatment experiments analogous to those described in Examples 1-3 will be carried out under a range of environmental conditions, including but not limited to varying photoperiod (e.g. about 12 hr to about 16 hr), temperature (e.g. about 25° C. to about 30° C.), light intensity (e.g. about 5 μmoles·m⁻²·s⁻¹ to about 240 μmoles·m⁻²·s⁻¹), blue light and UV-B light duration (e.g. about 4 hr to about 8 hr in order to enhance the nutritional quality of crops in controlled environments. Based on the exemplary results described herein, supplemental lighting treatment can significantly influence the overall levels of carotenoids, including cis- and trans-lycopene, as well as beta-carotene. Further experiments will focus on the mechanism involved in the physiological upregulation of carotenoid biosynthesis under UV-B and blue light conditioning. For example, this will include mapping the induced signal transduction pathways and identifying associated markers.

All of the materials and methods disclosed and claimed herein can be made and used without undue experimentation as instructed by the above disclosure. Although the materials and methods of this invention have been described in terms of preferred embodiments and illustrative examples, it will be apparent to those of skill in the art that variations can be applied to the materials and methods described herein without departing from the concept, spirit, and scope of the invention. All such similar substitutes and modifications apparent to those skilled in the art are deemed to be within the spirit, scope and concept of the invention as defined by the appended claims.

What is claimed is:

1. A method for increasing lycopene content in a tomato plant, the method comprising:
(a) obtaining a plant; and
(b) treating the plant with blue light, UV-B light, or a combination thereof, to induce accumulation of lycopene in said plant.

2. The method of claim 1, wherein said lycopene comprises all-trans-lycopene, 5-cis-lycopene, 9-cis-lycopene, 13-cis-lycopene, or a combination of any thereof.

3. The method of claim 2, wherein said lycopene comprises 5-cis-lycopene.

4. The method of claim 1, wherein said treating increases the ratio of lycopene cis-isomers to trans-isomers as compared to a control plant lacking said treatment.

5. The method of claim 1, wherein said treating is carried out:
at the beginning of the reproductive phase; or
after development of a tomato fruit.

6. The method of claim 1, wherein said treating is carried out in the presence of visible light.

7. The method of claim 1, wherein the plant is treated with blue light and UV-B light.

8. The method of claim 1, further comprising growing the plant under blue light, UV-B light, or a combination thereof.

9. The method of claim 1, wherein the plant is treated for about 1 hr, 2 hr, 3 hr, 4 hr, 5 hr, 6 hr, 7 hr, 8 hr, 9 hr, or 10 hr per day.

10. The method of claim 9, wherein the plant is treated with UV-B light for about 4 hr per day.

11. The method of claim 9, wherein the plant is treated with blue light for about 8 hr per day.

12. The method of claim 1, wherein the lycopene content in the plant is increased by about 5%, 10%, 20%, 30%, 40%, 50%, 60%, 70%, 80%, 90%, 100%, 150%, 175%, 200%, 225%, 250%, or 300% as compared to a control plant lacking said treatment.

13. The method of claim 1, wherein treating the plant is carried out in a controlled environment.

14. The method of claim 1, wherein the blue light comprises an intensity of about 100 μmol·m⁻² s⁻¹ to about 300 μmol·m⁻² s⁻¹.

15. The method of claim 1, wherein the UV-B light comprises an intensity of about 1 μmol·m⁻² s⁻¹ to about 10 μmol·m⁻² s⁻¹.

16. The method of claim 1, wherein the lycopene content in the plant is increased about 1.1-fold, 1.2-fold, 1.3-fold, 1.4-fold, 1.5-fold, 1.6-fold, 1.7-fold, 1.8-fold, 1.9-fold, 2.0-fold, 2.1-fold, 2.2-fold, 2.3-fold, 2.4-fold, 2.5-fold, 2.6-fold, 2.7-fold, 2.8-fold, 2.9-fold, or 3.0-fold as compared to a control plant lacking said treatment.

17. The method of claim 1, wherein said treating increases β-carotene content in the plant.

18. A method of increasing the nutritional content of a tomato, the method comprising:
(a) obtaining a plant; and
(b) treating the plant with blue light;
wherein said treating induces the conversion of trans-lycopene to cis-lycopene in the plant.

19. The method of claim 18, wherein said cis-lycopene comprises 5-cis-lycopene, 9-cis-lycopene, 13-cis-lycopene, or a combination of any thereof.

20. The method of claim 18, wherein the cis-lycopene content in the plant is increased about 1.1-fold, 1.2-fold, 1.3-fold, 1.4-fold, 1.5-fold, 1.6-fold, 1.7-fold, 1.8-fold, 1.9-fold, 2.0-fold, 2.1-fold, 2.2-fold, 2.3-fold, 2.4-fold, 2.5-fold, 2.6-fold, 2.7-fold, 2.8-fold, 2.9-fold, or 3.0-fold as compared to a control plant lacking said treatment.

21. The method of claim 18, wherein the plant is treated for about 1 hr, 2 hr, 3 hr, 4 hr, 5 hr, 6 hr, 7 hr, 8 hr, 9 hr, or 10 hr per day.

22. A method of increasing β-carotene content in a tomato, the method comprising:
(a) obtaining a plant; and
(b) treating the plant with UV-B light;
wherein said treating increases β-carotene content in the plant.

23. The method of claim 22, wherein said treating is carried out in a controlled environment.

24. The method of claim 22, wherein the plant is treated for about 1 hr, 2 hr, 3 hr, 4 hr, 5 hr, 6 hr, 7 hr, 8 hr, 9 hr, or 10 hr per day.
